(19) United States
(12) Patent Application Publication
(10) Pub. No.: US 2022/0105909 A1
(43) Pub. Date: Apr. 7, 2022

(54) VEHICLE BRAKE DEVICE

(71) Applicant: ADVICS CO., LTD., Kariya-shi, Aichi-ken (JP)

(72) Inventor: Masaki MARUYAMA, Kariya-shi, Aichi-ken (JP)

(73) Assignee: ADVICS CO., LTD., Kariya-shi, Aichi-ken (JP)

(21) Appl. No.: 17/425,735

(22) PCT Filed: Jan. 27, 2020
(86) PCT No.: PCT/JP2020/002713

§ 371 Date: Jul. 26, 2021

(30) Foreign Application Priority Data
Jan. 28, 2019 (JP) 2019-012018

(51) Int. Cl. B60T 8/172; B60T 8/171

(52) U.S. Cl. CPC B60T 8/172; B60T 2220/04; B60T 8/171

(57) ABSTRACT

A brake control device of a brake device includes a first acquisition unit acquiring an operating force PF inputted to a brake pedal, a second acquisition unit acquiring a stroke amount SS of the brake pedal, a target derivation unit deriving a target braking power BPTr based on the operating force PF and the stroke amount SS, and a brake controller controlling a vehicle braking power based on the target braking power BPTr. The target derivation unit increases or holds the target braking power BPTr when the operating force PF decreases while the stroke amount SS increases.

### TECHNICAL FIELD

The present disclosure relates to a vehicle brake device giving a vehicle a braking power corresponding to a braking operation by a driver of the vehicle.

### BACKGROUND ART

In Patent Literature 1, there is described an example of a vehicle brake control device setting a target braking power based on a pedal pressure by the driver of the vehicle and a stroke amount of a brake pedal. The pedal pressure is a sensor value based on a detection signal from a pedal-pressure sensor, and the stroke amount is a sensor value based on a detection signal from a stroke sensor.

In the device described in PTL 1, a first target braking power is derived so that a value becomes large as the pedal pressure increases, and a second target braking power is derived so that a value becomes large as the stroke amount increases. Then, a final target braking power is derived based on the first target braking power and the second target braking power. At this time, the final target braking power is derived so that the first target braking power accounts for a large part in the final target braking power as the pedal pressure increases.

### CITATION LIST

### Patent Literature

PTL 1: JP-A-2012-86674

### SUMMARY

### Technical Problem

When the driver operates a braking operation member such as the brake pedal, there may occur a phenomenon that an operating force corresponding to the pedal pressure which is the sensor value decreases even when the stroke amount of the braking operation member increases. In the case where such phenomenon occurs, the final target braking power may be decreased as the operating force decreases while the stroke amount increases in the device described in PTL 1. When the final target braking power is decreased, the vehicle braking power decreases while the stroke amount increases, which may give a sense of incongruity to the driver.

### Solution to Problem

A vehicle brake device for solving the above problems is applied to a vehicle in which a vehicle braking power is adjusted in accordance with operation of a braking operation member, which includes a first acquisition unit acquiring an operating force inputted to the braking operation member or a force corresponding to the operating force, a second acquisition unit acquiring a stroke amount of the braking operation member, a target derivation unit deriving a target braking power as a target of the vehicle braking power based on the operating force or the force corresponding to the operating force and the stroke amount, and a brake controller controlling the vehicle braking power based on the target braking power. Then, the target derivation unit increases or holds the target braking power when the operating force or the force corresponding to the operating force decreases while the stroke amount increases.

According to the above configuration, the target braking power is not decreased when the stroke amount increases by the operation of the braking operation member by the driver of the vehicle. As a result, a phenomenon that the vehicle braking power is decreased does not occur while the stroke amount increases even when the operating force decreases by controlling the vehicle braking power based on the target braking power. Accordingly, it is possible to suppress the sense of incongruity given to the driver when decelerating the vehicle by the braking operation by the driver.

### BRIEF DESCRIPTION OF DRAWINGS

FIG. 1 is a schematic configuration diagram illustrating a vehicle brake device according to an embodiment.

FIG. 2 is a block diagram illustrating a functional configuration of a brake control device of the brake device.

FIG. 3 is a flowchart for explaining a processing routine executed by the brake control device.

FIGS. 4A and 4B are timing charts at the time of a braking operation executed by a driver.

FIG. 5 is a flowchart for explaining a processing routine executed by the brake control device.

FIGS. 6A to 6E are timing charts at the time of a braking operation executed by the driver.

### DESCRIPTION OF EMBODIMENTS

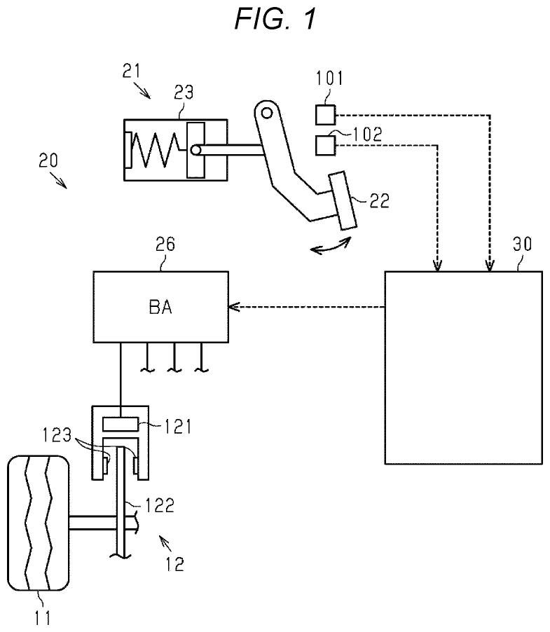

Hereinafter, a vehicle brake device according to an embodiment will be explained with reference to FIG. 1 to FIGS. 6A to 6E.

A vehicle including a brake device 20 according to the embodiment is illustrated in FIG. 1. A braking power is given to a wheel 11 of the vehicle by operation of a brake mechanism 12. The brake mechanism 12 is configured so that a force of pressing friction materials 123 onto a rotating body 122 integrally rotating with the wheel 11 becomes large as a WC pressure PWC which is a hydraulic pressure inside a wheel cylinder 121 increases. That is, the brake mechanism 12 can give a higher braking power to the wheel 11 as the WC pressure PWC increases.

The brake device 20 includes a hydraulic pressure generator 21, a brake actuator 26, and a brake control device 30. The hydraulic pressure generator 21 has a brake pedal 22 as an example of a braking operation member, and a master cylinder 23 generating a hydraulic pressure corresponding to the operation of the brake pedal 22 by a driver of the vehicle. The brake actuator 26 controls a braking power BP of the vehicle through adjustment of the WC pressure PWC inside the wheel cylinder 121. The braking power BP of the vehicle means a sum total of the braking power given to a plurality of wheels 11.

The brake control device 30 controls the operation of the brake actuator 26. Detection signals from various sensors are inputted to the brake control device 30. For example, an operating force sensor 101 and a stroke sensor 102 can be cited as the above sensors. The operating force sensor 101 detects an operating force PF to be inputted to the brake pedal 22 and outputs a detection signal corresponding to the detected operating force PF. The stroke sensor 102 detects a stroke amount SS of the brake pedal 22 and outputs a detection signal corresponding to the detected stroke amount SS.

The brake control device 30 sets a target braking power BPTr as a target of the braking power of the vehicle based on the operating force PF and the stroke amount SS. That is, the brake control device 30 has functions as a target braking power setting device. Then, the brake control device 30 controls the brake actuator 26 based on the set target braking power BPTr.

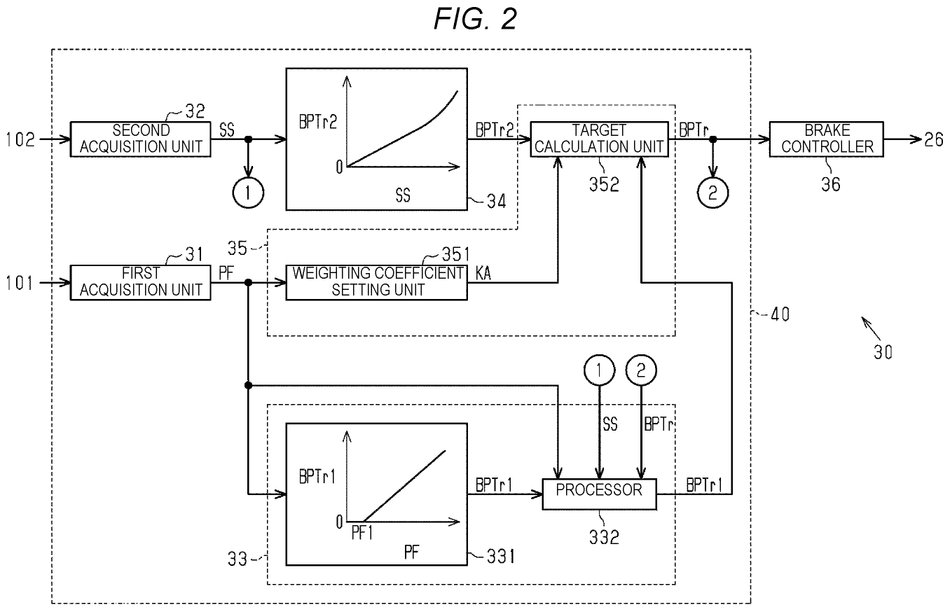

As illustrated in FIG. 2, the brake control device 30 includes a first acquisition unit 31, a second acquisition unit 32, a first derivation unit 33, a second derivation unit 34, a target derivation unit 35, and a brake controller 36 as functional units.

The first acquisition unit 31 acquires the operating force PF calculated based on the detection signal from the operating force sensor 101. That is, the operating force PF acquired by the first acquisition unit 31 is a sensor value.

The second acquisition unit 32 acquires the stroke amount SS calculated based on the detection signal from the stroke sensor 102. That is, the stroke amount SS acquired by the second acquisition unit 32 is a sensor value.

The first derivation unit 33 derives a first target braking power BPTr1 based on the operating force PF acquired by the first acquisition unit 31. The first derivation unit 33 includes a derivation reference unit 331 and a processor 332. The derivation reference unit 331 derives the first target braking power BPTr1 based on the operating force PF. Specifically, the derivation reference unit 331 sets the first target braking power BPTr1 to “0” when the operating force PF is smaller than a first operating force PF1. The derivation reference unit 331 derives the first target braking power BPTr1 so that a value becomes large as the operating force PF increases when the operating force PF is equal to or larger than the first operating force PF1.

The processor 332 determines the first target braking power BPTr1 based on the operating force PF acquired by the first acquisition unit 31, the stroke amount SS acquired by the second acquisition unit 32, and the target braking power BPTr derived by the target derivation unit 35. A specific method for determining the first target braking power BPTr1 will be described later.

The second derivation unit 34 derives a second target braking power BPTr2 based on the stroke amount SS acquired by the second acquisition unit 32. The second derivation unit 34 derives the second target braking power BPTr2 so that a value becomes large as the stroke amount SS increases.

The target derivation unit 35 includes a weighting coefficient setting unit 351 and a target calculation unit 352. The weighting coefficient setting unit 351 sets a predetermined value α as a weighting coefficient KA in the embodiment. The value α is a value larger than “0” and smaller than “1”.

The target calculation unit 352 executes weighted average processing for calculating the target braking power BPTr based on the first target braking power BPTr1 derived by the first derivation unit 33, the second target braking power BPTr2 derived by the second derivation unit 34, and the weighting coefficient KA set by the weighting coefficient setting unit 351. Specifically, the target derivation unit 352 calculates the target braking power BPTr by using the following relational expression (expression 1) in the weighted average processing. According to the relational expression (expression 1), the higher the first target braking power BPTr1 is, the higher the target braking power BPTr becomes. Moreover, the higher the second target braking power BPTr2 is, the higher the target braking power BPTr becomes. That is, a “target braking power setting device 40” is configured by the first acquisition unit 31, the second acquisition unit 32, the first derivation unit 33, the second derivation unit 34, and the target derivation unit 35 in the embodiment.

BPTr=BPTr1·KA+BPTr2·(1−KA) (Expression 1)

The brake controller 36 controls the brake actuator 26 based on the target braking power BPTr calculated by the target calculation unit 352. That is, the braking power BP of the vehicle is controlled based on the target braking power BP. Accordingly, the braking power BP of the vehicle can be approximated to the target braking power BPTr.

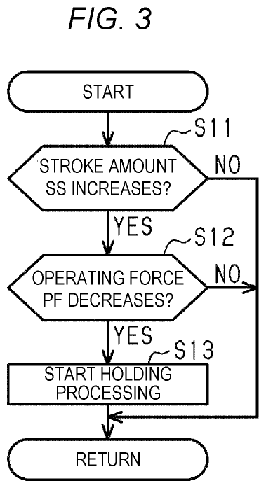

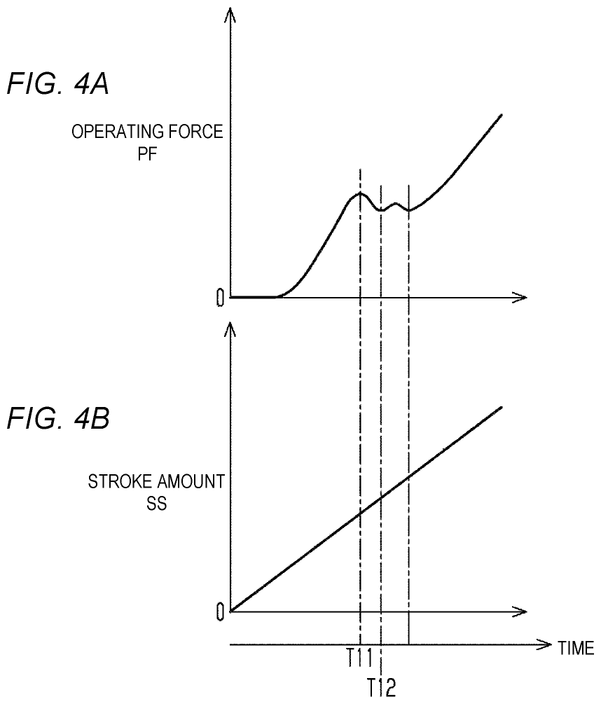

Next, a processing routine executed by the processor 332 for starting holding processing of holding the first target braking power BPTr1 will be explained with reference to FIG. 3, FIGS. 4A and 4B. The holding processing is an example of “prescribed processing”. The processing routine is executed repeatedly in a case where the holding processing is not executed while the braking operation is executed.

As illustrated in FIG. 3, the processor 332 determines whether the stroke amount SS increases or not in the processing routine (S11). When it is not determined that the stroke amount SS increases (S11: NO), the stroke amount SS is held or decreased; therefore, the processor 332 ends the processing routine once without executing the holding processing. In this case, the first target braking power BPTr1 derived by the derivation reference unit 331 is outputted to the target calculation unit 352.

On the other hand, when it is determined that the stroke amount SS increases (S11: YES), the processor 332 determines whether the operating force PF decreases or not (S12). When it is not determined that the operating force PF decreases (S12: NO), the operating force PF is held or increased; therefore, the processor 332 ends the processing routine once without executing the holding processing. In this case, the first target braking power BPTr1 derived by the derivation reference unit 331 is outputted to the target calculation unit 352.

On the other hand, when it is determined that the operating force PF decreases (S12: YES), the processor 332 starts the holding processing (S13). The processor 332 gives the same value as a prescribed braking power BPTr1A to the first target braking power BPTr1 in the holding processing. The prescribed braking power BPTr1A corresponds to the first target braking power BPTr1 at the time when a state where determination that the operating force PF decreases is not made is transferred to a state where the determination is made. Then, the processor 332 ends the processing routine. That is, when the operating force PF decreases while the stroke amount SS increases, the first target braking power BPTr1 inputted to the target calculation unit 352 is held at a value obtained when decrease of the operating power PF begins to be determined.

As illustrated in FIGS. 4A and 4B, the operating force PF increases under a state where the stroke amount SS increases before a timing T11. Therefore, the holding processing is not executed before the timing T11. As a result, the first target braking power BPTr1 used for calculating the target braking power BPTr in the target calculation unit 352 becomes high as the operating force PF increases. That is, the first target braking power BPTr1 inputted to the target calculation unit 352 is the same as the first target braking power BPTr1 derived by the derivation reference unit 331. However, the operating force PF decreases while the stroke amount SS increases after the timing T11. Therefore, after the timing T11, the first target braking power BPTr1 used for calculating the target braking power BPTr in the target calculation unit 352 is held at the value of the first target braking power BPTr1 derived at the timing T11 due to the execution of the holding processing. In this case, the first target braking power BPTr1 used for calculating the target braking power BPTr in the target calculation unit 352 is a value different from the first target braking power BPTr1 derived in the derivation reference unit 331.

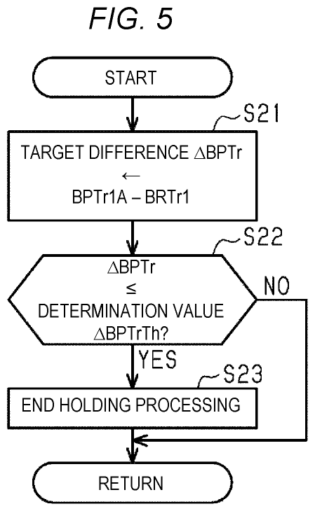

Next, a processing routine executed by the processor 332 will be explained with reference to FIGS. 4A and 4B, and FIG. 5. In the processing routine, determination for whether the holding processing is ended or not is made. The processing routine is executed repeatedly in a case where the holding processing is executed while the braking operation is performed and the operating force PF increases.

As illustrated in FIG. 5, the processor 332 calculates a value obtained by subtracting the first target braking power BPTr1 from the above prescribed braking power BPTr1A as a target difference ΔBPTr in the processing routine (S21). The first target braking power BPTr1 used for calculating the target difference ΔBPTr is a value outputted from the derivation reference unit 331.

Subsequently, the processor 332 determines whether the calculated target difference ΔBPTr is equal to or smaller than a determination value ΔBPTrTh or not (S22). The first target braking power BPTr1 becomes high when the operating force PF begins to increase; therefore, the target difference ΔBPTr becomes small. In a case where the calculated target difference ΔBPTr is equal to or smaller than the determination value ΔBPTrTh, the operating force PF is approximated to a value at the time of starting the holding processing. Accordingly, the first target braking power BPTr1 does not largely change even when the holding processing is ended. That is, the determination value ΔBPTrTh is a reference for determining whether the operating force PF which has decreased once recovers to a value close to the value at the time of starting the holding processing or not. The determination value ΔBPTrTh may be set in accordance with the value of the operating force PF at the time of starting the holding processing. For example, the determination value ΔBPTrTh may be set so that the value becomes large as the value of the operating force PF at the time of starting the holding processing becomes large. The determination value ΔBPTrTh may be a value which has been previously set.

When the target difference ΔBPTr is larger than the determination value ΔBPTrTh in Step S22 (NO), the processing routine is ended once. That is, in the case where the target difference ΔBPTr is larger than the determination value ΔBPTrTh, the holding of the first target braking power BPTr1 used for calculating the target braking power BPTr in the target calculation unit 352 is maintained even when the operating force PF begins to increase again as a part after a timing T12 in FIGS. 4A and 4B.

Returning to FIG. 5, when the target difference ΔBPTr is equal to or smaller than the determination value ΔBPTrTh in Step S22 (YES), the processor 332 ends the holding processing (S23). Accordingly, the first target braking power BPTr1 used for calculating the target braking power BPTr in the target calculation unit 352 begins to increase. Then, the processor 332 ends the processing routine.

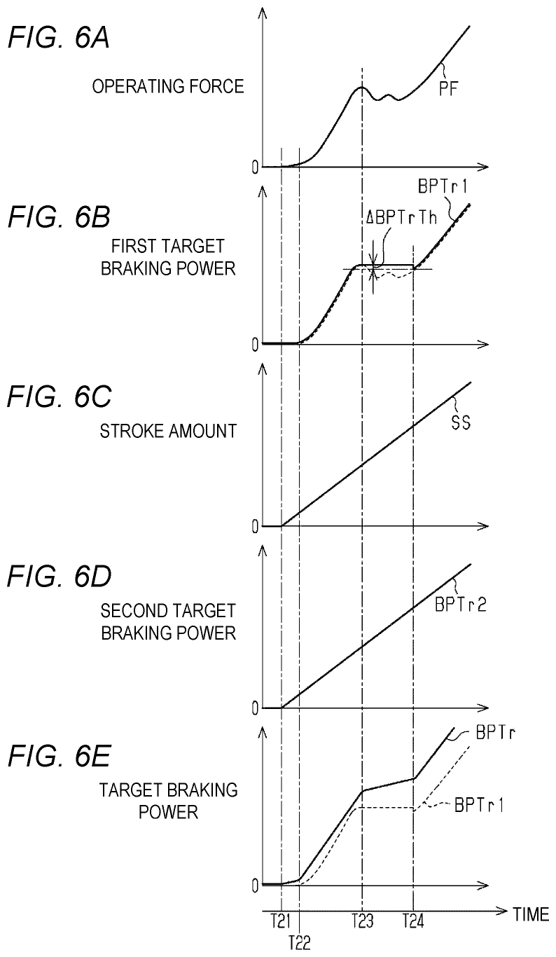

Next, operation and effect of the embodiment will be explained with reference to FIGS. 6A to 6E.

As illustrated in FIGS. 6A, 6B, 6C, 6D, and 6E, the braking operation is started from a timing T21. Then, both of the stroke amount SS and the operating force PF of the brake pedal 22 begin to increase from the timing T21. Then, the second target braking power BPTr2 begins to increase from the timing T21; however, the first target braking power BPTr1 begins to increase from a timing T22 slightly later than the timing T21. Accordingly, the target braking power BPTr becomes high in accordance with the increase of the second target braking power BPTr2 in a period from the timing T21 to the timing T22. As the first target braking power BPTr1 begins to increase after the timing T22, an increase rate of the target braking power BPTr becomes higher as compared with a rate before the timing T22.

In a case where the target braking power BPTr is higher than “0”, the operation of the brake actuator 26 is controlled based on the target braking power BPTr. Accordingly, the braking power BP is given to the vehicle. That is, the braking power BP of the vehicle is increased in accordance with the increase of the target braking power BPTr.

The operating force PF begins to decrease at a timing T23 while the stroke amount SS increases. Then, the first target braking power BPTr1 derived by the derivation reference unit 331 decreases as illustrated by a broken line in FIG. 6B. However, the holding processing is executed when the operating force PF begins to decrease while the stroke amount SS increases in the embodiment. Accordingly, the first target braking power BPTr1 used for calculating the target braking power BPTr in the target calculation unit 352 is held as illustrated by a solid line in FIG. 6B. As a result, even when the operating force PF decreases while the stroke amount SS increases, the first target braking power BPTr1 used for calculating the target braking power BPTr in the target calculation unit 352 is not decreased as illustrated in FIG. 6E. That is, when the stroke amount SS increases by the braking operation by the driver of the vehicle, the target braking power BPTr does not decrease. As a result, a phenomenon that the braking power BP of the vehicle is decreased does not occur while the stroke amount SS increases even when the operating force PF decreases. Accordingly, it is possible to suppress a sense of incongruity given to the driver when decelerating the vehicle by the braking operation of the driver.

Next, the end of holding processing will be explained. In the example illustrated in FIGS. 6A to 6E, the operation force PF which has decreased begins to increase after the timing T23 when the holding processing is started. Then, the first target braking power BPTr1 changes in accordance with the change of the operating force PF. The above-described target difference ΔBPTr becomes equal to or smaller than the determination value ΔBPTrTh at a timing T24 after the first target braking power BPTr1 repeatedly increases and decreases; therefore, the holding processing is ended. As the holding processing is ended in accordance with the decrease of the difference between the first target braking power BPTr1 and the prescribed braking power BPTr1A, it is possible to suppress large variation of the target braking power BPTr before and after the end of holding processing. As a result, it is possible to suppress the sense of incongruity caused by the end of holding processing given to the driver.

The above embodiment can be achieved by modification described as follows. The above embodiment and the following modification examples can be achieved by being combined with each other in a scope not technically inconsistent.
The value of the determination value ΔBPTrTh may be “0”. In this case, when the first target braking power BPTr1 beginning to increase reaches the prescribed braking power BPTr1A, the holding processing is ended.
In the above embodiment, it is also preferable that the holding processing is ended when a difference between the operating force PF beginning to increase and the operating force PF at the time of starting the holding processing becomes equal to or smaller than a prescribed value. In this case, the prescribed value may be “0”. In the case where the prescribed value is “0”, the holding processing is ended when the operating force PF beginning to increase reaches the value of the operating force PF at the time of starting the holding processing.
In the above embodiment, the weighting coefficient KA is fixed to the value α. However, if the target braking power BPTr can be increased or held when the operating force PF decreases while the stroke amount SS increases, the weighting coefficient KA can be variable. For example, the weighting coefficient KA can be variable in accordance with the operating force PF.
The execution of holding processing may be ended on condition that the operating force PF does not decrease during the execution of holding processing.
When the holding processing is started during the braking operation, the holding processing may be ended on condition that the braking operation is released.
If the target braking power BPTr can be increased or held when the operating force PF decreases while the stroke amount SS increases, it is not necessary to execute the holding processing when the operating force PF decreases while the stroke amount SS increases. For example, the first target braking power BPTr1 derived by the derivation reference unit 331 can be used for calculating the target braking power BPTr. In a case where the target braking power BPTr at the time of detecting the decrease of the operating force PF while the stroke amount SS increases is a reference target braking power BPTrA, the target braking power BPTr may be held at the reference target braking power BPTrA while the operating force PF decreases. Moreover, when the operating force PF decreases while the stroke amount SS increases, the target braking power BPTr may be increased to be higher than the reference target braking power BPTrA by an amount corresponding to an increment of the second target braking power BPTr2.
In the above embodiment, both of the first target braking power BPTr1 based on the operating force PF and the second target braking power BPTr2 based on the stroke mount SS are derived, and the target braking power BPTr is calculated based on the first target braking power BPTr1 and the second target braking power BPTr2. However, it is not always necessary to use both of the first target braking power BPTr1 and the second target braking power BPTr2 for calculating the target braking power BPTr as long as the target braking power BPTr can be derived by taking both of the operating force PF and the stroke amount SS into account.
The first target braking power BPTr1 may be derived based on not the operating force PF inputted to the brake pedal 22 but a force corresponding to the operating force PF. As such force, for example, a pressure generated in the master cylinder 23 in accordance with the operation of the brake pedal 22 can be cited. In this case, it is preferable to provide a detection unit capable of detecting a pressure to be inputted to the master cylinder 23 or a pressure outputted from the master cylinder 23 in accordance with the operation of the brake pedal 22.
Members other than the brake pedal 22 may be adopted as the braking operation member as long as the member can be operated by the driver. As the braking operation member other than the brake pedal 22, for example, a brake lever or the like can be cited.
In the above embodiment, the value of the first target braking power BPTr1 is held at a value obtained when the operating force PF is determined to decrease in the case where the operating force PF decreases while the stroke amount SS increases. It is also preferable that the value of the first target braking power BPTr1 is not held. For example, it is also preferable to execute processing of gradually increasing the value of the first target braking power BPTr1 as an example of prescribed processing in the case where the operating force PF decreases while the stroke amount SS increases. In this case, an increment of the first target braking power BPTr1 per unit time may be set to a value smaller than an increment of the operating force PF before decreasing, a value corresponding to an increment of the stroke amount, or a prescribed value which has been previously set.

1. A vehicle brake device applied to a vehicle in which a vehicle braking power is adjusted in accordance with operation of a braking operation member, comprising:
a first acquisition unit acquiring an operating force inputted to the braking operation member or a force corresponding to the operating force;
a second acquisition unit acquiring a stroke amount of the braking operation member;
a target derivation unit deriving a target braking power as a target of the vehicle braking power based on the operating force or the force corresponding to the operating force and the stroke amount; and
a brake controller controlling the vehicle braking power based on the target braking power,
wherein the target derivation unit increases or holds the target braking power when the operating force or the force corresponding to the operating force decreases while the stroke amount increases.

2. The vehicle braking device according to claim 1, further comprising:
a first derivation unit deriving a first target braking power so that a value becomes large as the operating force or the force corresponding to the operating force increases; and
a second derivation unit deriving a second target braking power so that a value becomes large as the stroke amount increases,
wherein the target derivation unit derives the target braking power so that a value becomes large as the first target braking power increases, and the value becomes large as the second target braking power increases, and
the first derivation unit executes prescribed processing of holding or increasing the first target braking power when the operating force or the force corresponding to the operating force decreases while the stroke amount increases.

3. The vehicle braking device according to claim 2,
wherein, when the operating force or the force corresponding to the operating force begins to increase under a state where the prescribed processing is executed, the first derivation unit ends the prescribed processing on condition that a difference between the operating force or the force corresponding to the operating force and the operating force or the force corresponding to the operating force obtained when execution of the prescribed processing is started becomes smaller than a determination value.
